(19) United States
(12) Patent Application Publication
(10) Pub. No.: US 2021/0002817 A1
(43) Pub. Date: Jan. 7, 2021

(54) CERAMIC COATED ANTIBACTERIAL FABRIC, AND METHOD FOR MANUFACTURING THE SAME

(71) Applicants: Bong-hak LIM, Taebaek-si (KR); Jong-hui AN, Taebaek-si (KR); Bo-ra LIM, Taebaek-si (KR)

(72) Inventors: Bong-hak LIM, Taebaek-si (KR); Jong-hui AN, Taebaek-si (KR); Bo-ra LIM, Taebaek-si (KR)

(21) Appl. No.: 16/912,997

(22) Filed: Jun. 26, 2020

(30) Foreign Application Priority Data
Jul. 2, 2019 (KR) 10-2019-0079417

(51) Int. Cl. D06M 11/76; D06M 10/06; D06B 19/00; D06M 17/00; D06M 11/79; D06M 15/03; C09D 5/16

(52) U.S. Cl. CPC D06M 11/76; D06M 10/06; D06B 19/0064; C09D 5/1618; D06M 11/79; D06M 15/03; D06M 17/00

(57) ABSTRACT

A method for manufacturing a ceramic-coated antibacterial fabric includes adding and mixing a ceramic component, calcium carbonate, a binder, and a dispersant into water, thereby to prepare a ceramic solution; heating the ceramic solution to 110 to 130° C., then immersing a fabric in the heated ceramic solution for 100 to 200 minutes, and then drying the fabric for 100 to 150 minutes at a temperature of 50 to 70° C., thereby to form a first coated ceramic layer on the fabric; and subsequently, heating the ceramic solution to 70 to 90° C., then immersing the fabric having the first coated ceramic layer thereon in the heated ceramic solution for 100 to 200 minutes, and then drying the fabric for 100 to 150 minutes at a temperature of 50 to 70° C., thereby to form a second coated ceramic layer on the first coated ceramic layer on the fabric.

### CROSS-REFERENCE TO RELATED APPLICATION

This application claims priority under 35 U.S.C. § 119(a) to Korean Patent Application No. 10-2019-0079417 (filed on Jul. 2, 2019), which is hereby incorporated by reference in its entirety.

### BACKGROUND

The present disclosure relates to a method for manufacturing a ceramic-coated antibacterial fabric having excellent appearance and excellent antimicrobial effect and antimicrobial persistence, the method including firmly binding a ceramic component having antibacterial activity to a fabric and finishing a surface of the fabric to be smooth, and relates to an antibacterial fabric manufactured by the method.

A fiber fabric is used as a basic material for various products including clothing. Types and processing methods thereof are remarkably diverse. Interest in functional fiber fabrics that have various functions is increasing.

Garment products manufactured from textile fabrics are directly in contact with a human body. Thus, sweat from the body may cause unpleasant smell. Microorganisms harmful to the human body may be inhabited and multiplied using secretions secreted from the human body as a nutrient source, thereby causing various diseases. Further, color change and embrittlement are factors that deteriorate a quality such as durability and fastness of textile products. In order to prevent such problems, antibacterial, antifungal, and deodorizing processes are performed on textile products.

Currently, there are many types of antibacterial agents used for antibacterial processing, which may be classified into an organic antibacterial agent and an inorganic antibacterial agent. The organic antibacterial agent has advantages in that it is relatively easy to process the organic antibacterial agent, compared to the inorganic antibacterial agent, and the organic antibacterial agent does not significantly affect mechanical properties, transparency, and color of a final product.

The organic antibacterial agent may include methyl paraben and propyl paraben based antibacterial agents. The organic antibacterial agents have a bad effect on biological skin cells and cause skin irritation. A harmfulness of the organic antibacterial agent to the human body has been reported. Thus, the inorganic antibacterial agent that may compensate for the shortcomings of the organic antibacterial agent have been attracting attention.

In the inorganic antibacterial agent, metal ions having excellent antibacterial properties such as sliver (Ag), copper (Cu), manganese (Mn), and zinc (Zn) ions are substituted onto inorganic carriers such as zeolite and silica alumina. The inorganic antibacterial agent has a three-dimensional skeletal structure with fine pores defined therein. Thus, the inorganic antibacterial agent has a large specific surface area and excellent heat resistance. However, the inorganic antibacterial agents may not adhere firmly to fibers or fabrics and may have durability deterioration due to washing.

In order to solve these shortcomings of the inorganic antibacterial agents, Korean Patent No. 1134850 discloses a method for producing a sheath/core composite filament including melt-spinning alkali-extractable polyester-based polymer as a core component and extractable polyester polymer containing modified polyamide polymer and inorganic particles.

Korean Patent No. 1577403 discloses antimicrobial fibers and fabrics that are manufactured by mixing carbon compound, iron oxide compound (ferrous oxide, ferric oxide, triiron tetraoxide), metal oxide (aluminum oxide, calcium oxide, magnesium oxide, zinc oxide, and manganese dioxide, silicon dioxide and titanium dioxide) with a spinning solution and spinning the mixture.

The fabrics produced using the above prior art inventions have an advantage of excellent washing durability since they contain antimicrobial components in the spinning solution during the manufacturing thereof. However, the antimicrobial components are trapped inside the polymer so that the antimicrobial activity is not sufficiently exhibited and inorganic antibacterial particles cause the filament to be cut, resulting in fiber strength deterioration.

Korean Patent No. 1895370 discloses a method of preparing an antibacterial fabric, the method including preparing an antibacterial coating agent that contains a calcium antibacterial agent containing one or a mixture of two or more selected from the group consisting of calcium carbonate, calcium oxide, and hydrogen ion-containing calcium, and further contains an aqueous binder and water; immersing a fabric material in the antibacterial coating agent to provide the antibacterial coating agent to the fabric; and fixing the fabric material provided with the antibacterial agent by conducting a heat treatment thereon.

Korean Patent No. 0768938 provides a coated fabric in which rosin is applied to a top of a fabric, and antibacterial natural substances such as olive, cinnamon, ginger, pine, allium grass, spearmint, persimmon oil, tansy chrysanthemum, salvia, herbs is coated thereon, and the fabric is cooled and a protective coating is formed on the antibacterial natural substance.

The fabrics produced using the above prior art inventions have advantages of being friendly to the human body and the environment and having excellent antibacterial and antimicrobial persistence. However, since the antimicrobial material is covered with the protective coating, the antibacterial activity is low and elasticity and flexibility of the fabric are poor due to the rosin and protective coating.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

A purpose of the present disclosure is to provide a manufacturing method of a ceramic coated antibacterial fabric that prevents a hand value of the fabric from being degraded due to the ceramic antibacterial material contained in the fabric, while having excellent antibacterial effect and antimicrobial persistence, and to provide an antibacterial fabric manufactured by the method.

Purposes in accordance with the present disclosure are not limited to the above-mentioned purpose. Other purposes and advantages in accordance with the present disclosure as not mentioned above may be understood from following descriptions and more clearly understood from embodiments in accordance with the present disclosure. Further, it will be readily appreciated that the purposes and advantages in accordance with the present disclosure may be realized by features and combinations thereof as disclosed in the claims.

One aspect of the present disclosure provides a method for manufacturing a ceramic-coated antibacterial fabric, the method comprising: adding and mixing 70 to 90 parts by weight of a ceramic component, 5 to 15 parts by weight of calcium carbonate, 10 to 20 parts by weight of a binder, and 0.1 to 0.5 parts by weight of a dispersant into 100 parts by weight of water, thereby to prepare a ceramic solution, wherein the ceramic component includes at least one selected from a group consisting of bentonite, diatomite, illite, zeolite, and pozzolan; heating the ceramic solution to 110 to 130° C., then immersing a fabric in the heated ceramic solution for 100 to 200 minutes, and then drying the fabric for 100 to 150 minutes at a temperature of 50 to 70° C., thereby to form a first coated ceramic layer on the fabric; and subsequently, heating the ceramic solution to 70 to 90° C., then immersing the fabric having the first coated ceramic layer thereon in the heated ceramic solution for 100 to 200 minutes, and then drying the fabric for 100 to 150 minutes at a temperature of 50 to 70° C., thereby to form a second coated ceramic layer on the first coated ceramic layer on the fabric.

In one implementation, the method further comprises, before preparing the ceramic solution, modifying the bentonite, wherein the modifying of the bentonite includes: mixing 80 to 120 parts by weight of quaternary ammonium salt with 100 parts by weight of bentonite to form a mixture; adding the mixture into water heated to 80 to 100° C. and performing reaction of the mixture for 5 to 7 hours; and filtering a reaction product to remove filtrate therefrom and washing the product with water and drying the product, thereby to prepare a modified bentonite, wherein the ceramic solution contains the modified bentonite.

In one implementation, the ceramic solution further contains 1 to 3 parts by weight of a cream based on 100 parts by weight of water.

In one implementation, the ceramic solution further contains 3 to 7 parts by weight of cyclodextrin based on 100 parts by weight of water.

In one implementation, the cyclodextrin includes γ-cyclodextrin.

In one implementation, a viscosity of the ceramic solution is in a range of 500 to 1500 cps, wherein a pick-up ratio thereof in each of the formation of the first coated layer and the formation of the second coated layer is in a range of 12 to 18% by weight.

One aspect of the present disclosure provides a ceramic-coated antibacterial fabric manufactured by the method as defined above.

Effects in accordance with the present disclosure may be as follows but may not be limited thereto.

In the ceramic coated antibacterial fabric according to the present disclosure, the ceramic component coated on the fabric inhibits the growth of various bacteria, thereby to prevent the bacteria from invading the human body through the antibacterial fabric.

Further, the ceramic component particles are firmly attached to the fabric, and thus is not easily detached from the fabric via repeated washing. Thus, the antibacterial effect lasts for a longer time duration. The coating surface is finished to be smooth, thereby to achieve clean appearance and good cleanliness.

In addition to the effects as described above, specific effects in accordance with the present disclosure will be described together with the detailed description for carrying out the disclosure.

### BRIEF DESCRIPTION OF THE DRAWINGS

FIG. 1 is a test report in which the antibacterial performance of the ceramic coated antibacterial fabric manufactured by the method of the present disclosure is compared to that of a conventional fabric.

### DETAILED DESCRIPTION

Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

Descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entire list of elements and may not modify the individual elements of the list.

In addition, it will also be understood that when a first element or layer is referred to as being present “on” a second element or layer, the first element may be disposed directly on the second element or may be disposed indirectly on the second element with a third element or layer being disposed between the first and second elements or layers. It will be understood that when an element or layer is referred to as being “connected to”, or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A ceramic coated antibacterial fabric according to the present disclosure is manufactured by repeating a process of immersing a fabric in a ceramic solution, and drying the fabric. In this process, ceramic particles are firmly adhered to and coated on the fabric, thereby continuously exerting antimicrobial performance. Further, the ceramic coating may allow the surface of the fabric not to be rough.

The ceramic solution is produced by adding and mixing a ceramic component, calcium carbonate, a binder, and a dispersant into water. The ceramic component may be selected according to a purpose of the fabric and to enable adsorption and removal of bacteria, heavy metals, radioactive substances such as radon, and moisture in air. The ceramic component may include at least one selected from a group consisting of bentonite, diatomite, illite, zeolite, pozzolan, and mixtures thereof.

Bentonite refers to a clay made of expandable three-layer plate (Si—Al—Si) and has a layered structure and is known to have higher adsorption performance than that of zeolite among inorganic adsorption materials. Bentonite adsorbs and removes bacteria, odor components, moisture, etc., and has excellent adsorption ability of moisture and odor components in the air.

In order to further improve the adsorption capacity of bentonite, the bentonite may be modified and then coated on the fabric. To this end, bentonite is reacted with quaternary ammonium salt to improve the adsorption capacity of bentonite.

To this end, 80 to 120 parts by weight of the quaternary ammonium salt is mixed with 100 parts by weight of bentonite and then the mixture is placed in water heated to 80 to 100° C. for reaction for 5 to 7 hours. A reaction product is filtered to remove filtrate, and is washed with water and dried to produce modified bentonite.

The quaternary ammonium salt refers to a salt obtained by binding quaternary ammonium ion (NR₄⁺) to halogen anions such as chlorine ion (Cl⁻), bromine ion (Br⁻) to exhibit a property of cationic surfactant. When the quaternary ammonium salt reacts with bentonite, a hydrophilic group of the quaternary ammonium salt is bound to an interlayer wall of bentonite, and thus lipophilic groups of the quaternary ammonium salt are arranged outwardly of bentonite.

Thus, the hydrophilic groups are arranged to the outside while a lipophilic group of the quaternary ammonium salt which is not bound to bentonite is disposed between the arranged lipophilic groups.

The hydrophilic groups of the quaternary ammonium salt arranged on a surface of bentonite as described above adsorbs moisture, and thus may adsorb and remove more moisture such as sweat discharged from a human skin along with the ability of bentonite to adsorb moisture.

Diatomite refers to a sediment or a rock in which remains of a single-celled diatom are accumulated. Diatomite is primarily composed of silicon dioxide (SiO₂). Most of diatomite is present in an amorphous silica form. However, diatomite may be present in a crystalline silica form. Due to a complex structure of a porous diatom itself and first and second pores of a shell, a density of diatomite is very low. Due to numerous gaps in a diatom cell, diatomite may adsorb and remove microscopic bacteria and adsorb some radon components.

Illite is a representative clay mineral, and is fine and has a large surface area and is highly reactive. Pores are formed between layers of a layered structure thereof, such that a porosity is high and a sterilization ability is excellent. Thus, illite removes bacteria and fungi in the air and adsorbs and removes heavy metals.

Zeolite is an aluminum silicate mineral of a porous crystal mainly containing an alkali metal or an alkaline earth metal. In zeolite, a tetrahedron of (Si,Al)O₄ forms a three-dimensional network framework using apical oxygens. Large pores are formed in a center thereof and water molecules and exchangeable cations are contained therein.

When heating at a relatively low temperature is carried out, water molecules are easily removed, but the skeleton of the zeolite structure does not change, such that the zeolite after the heating may adsorb harmful substances in the air. A chemical composition of zeolite may be represented by Wy(Si,Al)(O₂×nH₂O). W is mainly composed of sodium (Na) and calcium (Ca) and may contain potassium (K), magnesium (Mg), barium (Ba), and lithium (Li).

Zeolite has a pore of a certain size, and thus allows selectively passing smaller molecules than the pore therethrough and absorbs the same. Cations in a crystal structure thereof is easily exchangeable with other cations, thereby to exhibit excellent removal ability of harmful substances and deodorizing ability. In particular, zeolite strongly removes heavy metals and radon in the air and removes the same.

Pozzolan is a porous material, and is classified into natural pozzolan such as cement admixtures, soluble terra abla, silicate terra abla, and efflorescence of marl, and an artificial pozzolan such as fly-ash. Pozzolan contains a large amount of soluble silicic acid, and is not hydraulic. However, pozzolan may easily combine with lime and cure under presence of water.

Pozzolan has a high porosity and excellent sterilization ability as in the above illite, thereby to impart effects of removing bacteria, mold, and heavy metals in the air to the fabric.

The ceramic components are pulverized into fine particles of 200 to 500 mesh, and are used for the ceramic solution. As the ceramic particles are finer, these fine ceramic particles are inserted into micropores present in the fabric at a large amount, and a specific surface area thereof is larger and thus a contact area with a binder is larger, so that the ceramic particles are more firmly attached to the fabric and thus the ceramic coating may be stably maintained.

Calcium carbonate is non-toxic to the human body and has antibacterial activity against various harmful bacteria and microorganisms. Calcium carbonate may function as an extender and a reinforcing agent having excellent hardness, heat insulation, hygroscopicity, and hiding ability. Calcium carbonate has high hydrophilicity, low oil absorption, and excellent homogeneity, and thus is dispersed in water to form a suspension. Thus, calcium carbonate may control fluidity of ceramic component particles to allow the ceramic powders not to agglomerate and not to settle in the water and may allow the coating surface of the fabric to be smooth such that foreign substances adhering to the coating surface may be easily removed therefrom.

The binder plays a role in helping the ceramic component particles to stably adhere to the fabric. Latex or starch may be used as the binder. The dispersant may be selected from conventional inorganic dispersants, for example, isopropyl alcohol, sodium hexametaphosphate, n-butyl alcohol, n-butyl alcohol. The dispersant may help the calcium carbonate to allow the ceramic powders to be dispersed in water.

70 to 90 parts by weight of the ceramic components, 5 to 15 parts by weight of calcium carbonate, and 10 to 20 parts by weight of the binder and 0.1 to 0.5 parts by weight of the dispersant are mixed with each other in 100 parts by weight of water to prepare the ceramic solution. A viscosity of the ceramic solution as formulated as described above is in a range of 500 to 1500 cps, so that the ceramic particles are easily attached to the fabric.

In a coating process as a post process, the ceramic solution is heated and then coated on the fabric and then dried. In this connection, when the binder component such as latex and starch in the ceramic solution is heated, bubbles are generated and moisture is changed to water vapor and evaporates. In this state, when the ceramic solution having the viscosity is dried, bubble marks are formed on the coating layer, so that the surface of the coating is not smooth, and a portion of the fabric corresponding to the bubble marks has deteriorated physical properties such as hardness and strength.

To prevent this problem, an anti-foaming agent may be added to the ceramic solution. In this connection, the anti-foaming agent may destroy a chemical balance of the ceramic solution, thereby deteriorating the dispersibility of the calcium carbonate and the binding force of the binder, thereby adversely affecting the physical properties of the coating layer.

In order to solve this problem, it is preferable to add a cream to the ceramic solution. It is more preferable to add 1 to 3 parts by weight of the cream based on 100 parts by weight of water. The cream refers to an oil-based milk fat ingredient separated from milk, and having a small specific gravity, little volatility, and a large diffusion power. The cream may suppress air bubbles and allow the coating surface to be smooth. The cream may suppress the formation of bubble marks in the drying process after the coating process and may smooth the coating surface to prevent the appearance and physical properties of the coating layer from deteriorating.

Bonding of the ceramic components to the fabric is achieved via the binder. Repeated washing of the fabric may cause the binding force to be lowered so that the ceramic component particles may be detached from the fabric. Thus, there is a possibility that the antibacterial activity of the ceramic component is lowered.

To prevent this situation, cyclodextrin may be added to the ceramic solution. It is preferable to add 3 to 7 parts by weight of cyclodextrin based on 100 parts by weight of water.

Dextrin refers to hydrolysis products of several kinds that are created in an intermediate step during hydrolysis of starch to maltose. Dextrin is a hydrocolloid substancel, and is a polymer substance that increases viscosity or forms a gel. Cyclodextrin is a ring-shaped dextrin, and is classified into α-cyclodextrin (6), β-cyclodextrin (7), and γ-cyclodextrin (8), depending on the number of glucoses forming a ring.

Cyclodextrin has the ability to increase adhesion and viscosity and increase emulsification stability, so that the ceramic component particles may be firmly bound to the fabric, and the ceramic component particles are uniformly dispersed in the ceramic solution. Thus, cyclodextrin has the effect of supplementing the functions of the binder and the dispersant in the ceramic solution.

When adding the cream to the ceramic solution, there is a risk that the cream as a milk fat ingredient may not be uniformly dispersed in the ceramic solution using water as a solvent. In this connection, the cyclodextrin has a ring shaped molecular structure in which an inner face is oleophilic and an outer face is hydrophilic and has the emulsifying ability. Thus, the cyclodextrin collects the cream component inside the annular structure, thereby to provide the effect of uniformly dispersing the cream in the ceramic solution. The cyclodextrin may discharge the cream component into the water as the solvent of the ceramic solution in the heating process during the coating operation to be described later, so that the cream component may suppress the generation of the bubbles.

Further, the cyclodextrin has high thermal stability and has an effect of stabilizing a material that is decomposed by heat, thereby preventing the change in the physical properties of the ceramic solution due to the heat in the process of coating the ceramic solution on the fabric.

It is more preferable to use γ-cyclodextrin among cyclodextrins, which has the highest solubility in the water and the largest inner size of the ring, so that the γ-cyclodextrin has the ability to collect the cream and releases the collected cream at a high rate.

Next, the process of immersing the fabric in the ceramic solution and drying the fabric is repeated twice to coat the ceramic component particles on the fabric. A pick-up ratio may be adjusted by adding the immersion and drying processes depending on the type of the ceramic, the type of the fabric, and an application of the ceramic-coated antibacterial fabric.

After adding the ceramic solution into an immersion bath, the method first immerses the fabric in the solution for 100 to 200 minutes at 110 to 130° C., and then first drying the fabric for 100 to 150 minutes with hot air at 50 to 70° C. for a first coating. Then, the first coated fabric is second immersed in the immersion bath containing therein the ceramic solution at 70 to 90° C. for 100 to 200 minutes, and then second dried for 100 to 150 minutes with hot air at 50 to 70° C. for a second coating.

At the first immersion temperature, the ceramic solution is in a boiling state. Thus, the ceramic solution penetrates deep into the fabric and firmly adheres to the fabric. However, due to the bubbles generated from the binder and the water vapor, the bubble marks remain on the surface of the coating layer after the first heating process. The second immersion temperature is below a boiling point of each of the components in the ceramic solution, such that no bubbles or water vapor are created. The second coated layer covers the bubble marks of the first coated layer. Therefore, no bubble marks are formed on the second coated layer. No bubble marks remain on a final coated surface, such that the surface becomes smooth.

In addition, when performing the second coating process at the lower temperature than that in the first coating process, as described above, the binder among the first coated components may not melt at the second coating temperature, such that the first coated film does not melt and the cured state thereof may be stably maintained.

When the first coating temperature is below 110° C., the ceramic component is not sufficiently adhered to the fabric. When the second coating temperature is below 70° C., the ceramic component is not sufficiently adhered to the first coated film. Thus, the washing durability of the final fabric is low. On the contrary, when the first coating temperature exceeds 130° C., and the second coating temperature exceeds 90° C., there occurs energy loss and a risk that the bubble marks remains on the coating surface and the fabric shrinks.

Further, the first and second drying temperatures are lower than the first and second immersion temperatures, respectively. Thus, the coating film is not damaged during the drying process and the thermal damage to the fabric is prevented while the ceramic component is fixed to the fabric.

In the first and second coating processes, the fabric may be immersed in the ceramic solution in a pressurized state. A leveling agent used for dyeing may be added to the solution for uniform coating. A softener may be added to the solution to secure flexibility, and drapery, to prevent wrinkles of the coated antibacterial fabric.

A first ceramic solution at the time of the first coating and a second ceramic solution at the time of the second coating may have the same composition and the same mixing ratio. Alternatively, the first ceramic solution at the time of the first coating and the second ceramic solution at the time of the second coating may have different compositions and different mixing ratios based on an application of the ceramic coated antibacterial fabric.

The ceramic-coated antibacterial fabric as manufactured as described above has the pick-up ratio of 12 to 18% by weight at each of the first coating process and the second coating process and exhibits excellent antimicrobial properties without damaging the hand of the fabric. The ceramic coated antibacterial fabric may be subjected to a tenter processing or may be subjected to dyeing and then the tenter processing and thus may be commercialized.

The fabric to which the manufacturing method of the present disclosure may be applied is not particularly limited. The fabric to which the manufacturing method of the present disclosure may be applied may include natural fibers such as cotton, hemp, wool, synthetic fibers such as polyester, nylon, acrylic fibers, recycled fibers, semi-synthetic fibers, etc.

The ceramic-coated antibacterial fabric as manufactured as described above has excellent antibacterial ability and fastness to washing and thus may be widely used for various purposes such as fabrics for medical and infant use, curtains and bed covers.

Hereinafter, the present disclosure will be described in more detail based on following examples.

However, the following examples are only for illustrating the present disclosure, and the present disclosure is not limited to the following examples. Substitutions therewith and equivalents thereto may be made by the skilled person to the art within the scope of the technical idea of the present disclosure.

### EXAMPLE

1 ton of water was mixed with 160 g of bentonite, 160 g of diatomite, 160 g of illite, 160 g of zeolite, 160 g of pozzolan, 100 g of calcium carbonate, 150 g of latex and 2 g of n-butyl alcohol to produce a ceramic solution having a viscosity of 1000 cps.

The ceramic solution was placed in an immersion bath which was heated to 120° C. A polyester fabric was immersed in the heated solution for 150 minutes, then and was hanged on a drying rack and was dried for 120 minutes with 60° C. hot air. Thus, a first coated ceramic layer was formed on the fabric.

Then, the ceramic solution was put to another immersion bath which in turn was heated to 80° C. The fabric having the first coated layer thereon was immersed in the heated solution for 120 minutes, then was hung on a drying rack, and was dried using hot air at 60° C. for 120 minutes. Thus, a second coated ceramic layer was formed on the first coated layer. In this way, a ceramic coated antibacterial fabric was manufactured.

### TEST EXAMPLE

The manufactured fabric was commissioned to a SGS inspection agency, and an antibacterial performance thereof was measured according to JIS L 1902:2015E (antibacterial test method of fiber). A bare polyester fabric used in the example was used as a control which was compared with the ceramic coated antibacterial fabric manufactured in the above example.

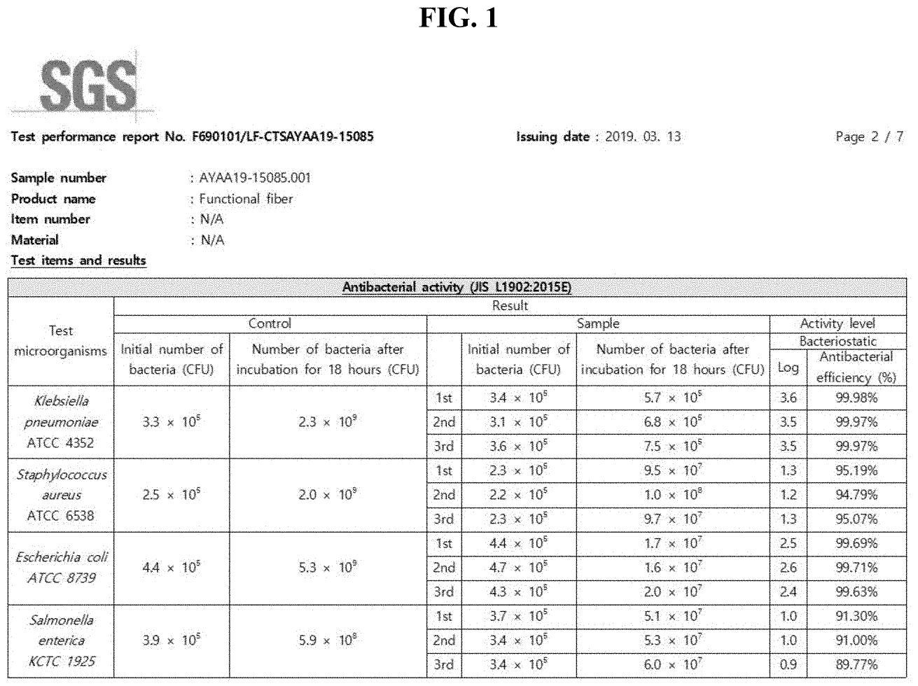

Strains used for the test were Klebsiella pneumococcus (ATCC 4352), Staphylococcus aureus (ATCC 6538), Escherichia coli (ATCC 8739), Salmonella enterica (KCTC1925). The test result is shown in FIG. 1.

Referring to FIG. 1, after 18 hours of incubation of the strains on the ceramic coated antibacterial fabric according to the present disclosure and on the control, each fungus species was multiplied by approximately 1500 to 12000 times on the control. However, each fungus species was multiplied by about 2 to 180 times on the ceramic coated antibacterial fabric according to the present disclosure. Thus, the ceramic coated antibacterial fabric according to the present disclosure exhibited an antibacterial efficiency of 89.77% or higher. The ceramic coated antibacterial fabric according to the present disclosure exhibited an antibacterial efficiency of 99.9% or higher against Klebsiella pneumococcus. Thus, the ceramic coated antibacterial fabric according to the present disclosure is particularly useful as a fabric in contact with a human body, such as a bed cover or clothing.

As described above, the present disclosure has been described with reference to the exemplified embodiments and the drawings, but the present disclosure is not limited to the embodiments and the drawings disclosed in the present specification. It is obvious that various modifications may be made by those skilled in the art within the scope of the present disclosure.

What is claimed is:

1. A method for manufacturing a ceramic-coated antibacterial fabric, the method comprising:
adding and mixing 70 to 90 parts by weight of a ceramic component, 5 to 15 parts by weight of calcium carbonate, 10 to 20 parts by weight of a binder, and 0.1 to 0.5 parts by weight of a dispersant into 100 parts by weight of water, thereby to prepare a ceramic solution, wherein the ceramic component includes at least one selected from a group consisting of bentonite, diatomite, illite, zeolite, and pozzolan;
heating the ceramic solution to 110 to 130° C., then immersing a fabric in the heated ceramic solution for 100 to 200 minutes, and then drying the fabric for 100 to 150 minutes at a temperature of 50 to 70° C., thereby to form a first coated ceramic layer on the fabric; and
subsequently, heating the ceramic solution to 70 to 90° C., then immersing the fabric having the first coated ceramic layer thereon in the heated ceramic solution for 100 to 200 minutes, and then drying the fabric for 100 to 150 minutes at a temperature of 50 to 70° C., thereby to form a second coated ceramic layer on the first coated ceramic layer on the fabric.

2. The method of claim 1, wherein the method further comprises, before preparing the ceramic solution, modifying the bentonite,
wherein the modifying of the bentonite includes:
mixing 80 to 120 parts by weight of quaternary ammonium salt with 100 parts by weight of bentonite to form a mixture;
adding the mixture into water heated to 80 to 100° C. and performing reaction of the mixture for 5 to 7 hours; and
filtering a reaction product to remove filtrate therefrom and washing the product with water and drying the product, thereby to prepare a modified bentonite,
wherein the ceramic solution contains the modified bentonite.

3. The method of claim 1, wherein the ceramic solution further contains 1 to 3 parts by weight of a cream based on 100 parts by weight of water.

4. The method of claim 3, wherein the ceramic solution further contains 3 to 7 parts by weight of cyclodextrin based on 100 parts by weight of water.

5. The method of claim 4, wherein the cyclodextrin includes γ-cyclodextrin.

6. The method of claim 1, wherein a viscosity of the ceramic solution is in a range of 500 to 1500 cps, wherein a pick-up ratio thereof in each of the formation of the first coated layer and the formation of the second coated layer is in a range of 12 to 18% by weight.

7. A ceramic-coated antibacterial fabric manufactured by the method of claim 1.
